(19) United States
(12) Patent Application Publication
(10) Pub. No.: US 2008/0189034 A1
(43) Pub. Date: Aug. 7, 2008

(54) Navigation apparatus

(75) Inventor: Wataru Sugiura, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/010,579

(22) Filed: Jan. 28, 2008

(30) Foreign Application Priority Data
Feb. 6, 2007 (JP) 2007-27187

(51) Int. Cl. G01C 21/00

(52) U.S. Cl. 701/209

(57) ABSTRACT

A navigation apparatus performs a travel guide in areas having no roads. Present positions of the vehicle are detected as swept path points with predetermined intervals. The detected swept path points are stored in a storage device such that the order of detection can be identifiable; thus, swept path data can be created. Thereafter, a present position of the vehicle is detected. A certain swept path point in the swept path data may be present within a predetermined range from the present position; further, the fifth swept path point in the forward direction may be present five swept path points ahead of the certain swept path point in the swept path data. In such a case, an orientation of the fifth swept path point is calculated relative to the heading direction. The calculated orientation of the fifth swept path point is indicated or announced using sounds.

### CROSS REFERENCE TO RELATED APPLICATION

This application is based on and incorporates herein by reference Japanese Patent Application No. 2007-27187 filed on Feb. 6, 2007.

### FIELD OF THE INVENTION

The present invention relates to a navigation apparatus in a vehicle for providing a travel guide in an area having no roads.

### BACKGROUND OF THE INVENTION

Patent document 1 discloses a navigation apparatus for providing a travel guide in an area including no roads.

When an off-road mode is demanded to the navigation apparatus in Patent document 1, the position calculation unit stops a map matching process. Moreover, the swept path record unit records the swept path of the vehicle. The map drawing unit draws a map image corresponding to a predetermined range near the swept path of the vehicle. The map drawing unit further draws a swept path of the vehicle on the map image, and the drawn map image is written in VRAM. The mark drawing unit draws a vehicle position mark indicative of a vehicle position, and outputs the mark to the image synthesis unit. The image synthesis unit synthesizes the image data stored in VRAM and the image data outputted from the mark drawing unit, and outputs the synthesized data in the display device. On the display screen of the display device, the map image of the predetermined region centering on the swept path of the vehicle is displayed.

Thus, the navigation apparatus in Patent document 1 only displays the map image of the predetermined region centering on the swept path. Therefore, in off-road travel based on the swept path data, the user may need to gaze at the display device to check the swept path.
Patent document 1: JP-2002-357431 A (corresponding to U.S. Pat. No. 6,356,837)

### SUMMARY OF THE INVENTION

It is an object to provide a navigation apparatus capable of performing a travel guide in an area, where no roads are present, to help prevent a need of gazing at a display device.

To achieve the above object, according to an example of the present invention, a navigation apparatus in a vehicle for providing a travel guide in an area having no roads is provided as follows. The navigation apparatus is provided as follows. A position detection unit is configured to detect a present position of the vehicle. A heading direction detection unit is configured to detect a heading direction of the vehicle. A swept path creation unit is configured to record, in a storage device, present positions detected by the position detection unit with predetermined distance intervals as swept path points such that individual detection orders, in which the present positions are detected, are identifiable, to thereby create swept path data indicative of a swept path of the vehicle. A travel guide unit is configured to provide a travel guide for a route following the swept path forward or backward by outputting a relative orientation of one of the swept path points with respect to the heading direction at the present position using a sound.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of a navigation apparatus according to an embodiment of the present invention;

FIG. 2 is a flowchart illustrating a swept path data creation process of the navigation apparatus;

FIG. 3 is a flowchart illustrating a travel guide process of the navigation apparatus;

FIGS. 4A, 4B are examples of display windows in a travel guide in the navigation apparatus; and

FIG. 5 is an example of a display window as a setting window in the navigation apparatus.

### DETAILED DESCRIPTION OF THE PREFERRED EMBODIMENTS

An embodiment according to the present invention will be explained with reference to drawings.

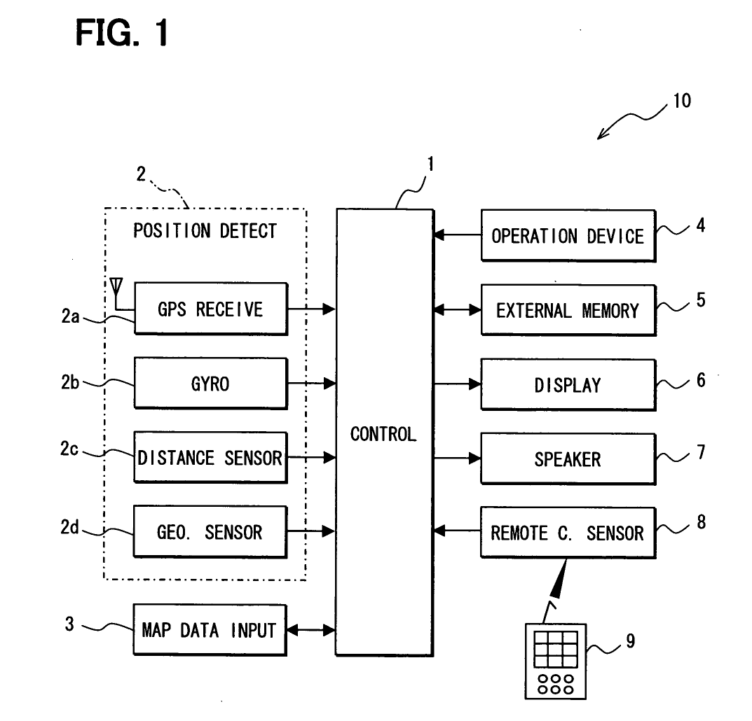

A navigation apparatus 10 according to the embodiment of the present invention is mounted in a subject vehicle. As shown in FIG. 1, the navigation apparatus 10 includes a position detection unit 2, a map data input unit 3, an operation device 4, an external memory 5, a display device 6, a speaker 7, a remote control sensor 8, and a control circuit 1 connected with the foregoing.

The control circuit 1 is a usual computer to contain a CPU, a ROM, a RAM, an I/O, and a bus line connected with the foregoing. The control circuit 1 executes data processing for the navigation apparatus 10 to execute various kinds of functions. For example, the control circuit 1 processes for a route guide function. When a destination is inputted via the operation device 4, an optimal route is automatically designated from the present position (or departure point) to the destination to thereby define a guide route. The guide route is then displayed. The technique of automatically designating the optimal route uses, for instance, the known Dijkstra method. Moreover, the control circuit 1 processes for a travel guide in an off-road area having no road data in map data. For instance, the travel guide is performed based on the swept path or performed to guide a route following the swept path forward or backward. The travel guide based on the swept path will be explained in detail later.

The position detection unit 2 includes following known sensors or the like: a GPS receiver 2a for GPS (Global Positioning System) detecting a present position of the vehicle based on electric waves from satellites, a gyroscope 2b, a distance sensor 2c, and a geomagnetic sensor 2d. The individual sensors or the like have different types of detection errors from each other; therefore, they are used to complement each other. In addition, part of the sensors or the like may be used depending on the required detection accuracy, or another sensor or the like such as a revolution sensor for the steering or vehicular sensor for following wheels may be used.

The map data input unit 3 is a storage medium which stores a map database including map data. The map data include road-related data and search-related data. The road-related data include road data, landmark data, facility data, and background data for displaying a map or performing a route guide. The search-related data include facility names, phone numbers, etc., for retrieving a destination or a facility near a destination. The storage medium includes a rewritable HDD (Hard Disk Drive) or the like because of required data volume or required handling instruction.

The operation device 4 may be a touch-sensitive switch, a hardware switch, or a joy switch for various inputs. The touch-sensitive switch is provided on a screen of the display device 6. The hardware switch is press-type buttons provided to surround the screen of the display device 6. The joy stick is provided to operate a cursor displayed on the screen of the display device 6 in multiple directions. For example, the operation device 4 is used for inputting, to the control circuit 1, varied information including positional information for destinations based on user's operation. The operation device 4 is further used for inputting, to the control circuit 1, an operation signal corresponding to a function, such as designation of a guide route to a destination from a present position, executed by the navigation apparatus 10.

The remote control sensor 8 and remote control 9 are remote control devices having functions equivalent to those of the operation device 4. The remote control 9 transmits infrared signals to the remote control sensor 8. The remote control sensor 8 converts the received signals to electric signals to thereby generate operation signals, which is inputted to the control circuit 1.

The external memory 5 stores, as needed, data dealt with in the control circuit 1. The stored data include swept path data to be explained later in detail.

Moreover, the external memory 5 includes a nonvolatile storage medium which data can be written to or read out from.

The display device 6 includes a main monitor (as a display screen) such as a color liquid crystal panel disposed in an instrument panel in the vehicle. This display device 6 displays road maps in proximity to the vehicle, which are generated from the map data stored in the map data input unit 3.

The speaker 7 outputs audio guide to reach destinations or travel guide based on swept paths. The travel guide will be explained later.

Next, an operation of the navigation apparatus 10 will be explained below.

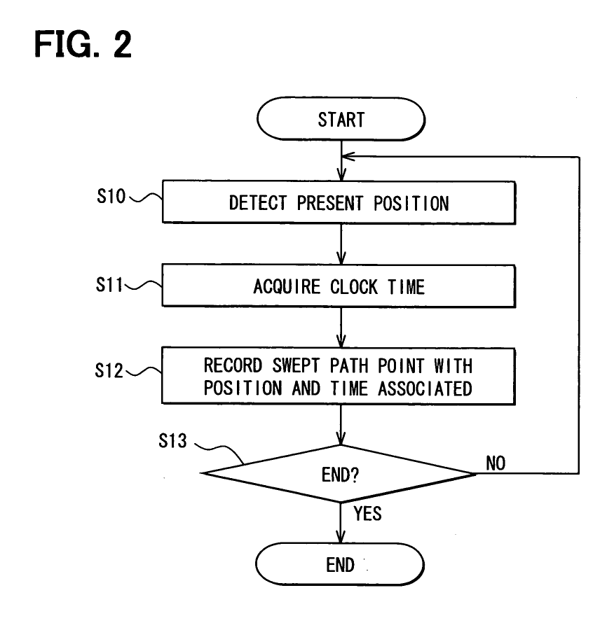

First, a creation process of swept path data is explained with reference to FIG. 2. The creation process is executed by the control circuit 1. The creation process is needed when executing a travel guide based on the swept path. The creation process is started when an operation signal for creation of swept path data is inputted via the operation device 4 or the remote control 9. The creation process is repeatedly executed with predetermined intervals (e.g., with predetermined distance intervals) until an operation signal for termination is inputted.

The swept path data are created when the vehicle travels in an off-road area having no roads, and are used when the vehicle returns along the swept path or when the vehicle travels again along the swept path.

At Step S10, the control circuit 1 detects a present position of the vehicle using the position detection unit 2. At Step S11, the control circuit 1 acquires present clock time as time information indicating a detection order, in which the present position is detected. The present clock time may be acquired from an internal clock of the control circuit 1, if the clock is available. Alternatively, it may be acquired as time information included in electric waves from GPS satellites via the GPS receiver 2a.

At Step S12, the control circuit 1 stores or records as a swept path point the present position detected at Step S10 in association with the present clock time acquired at Step S11 in the external memory 5 etc. At Step S13, it is determined whether or not an operation signal for termination is inputted via the operation device 4 or the remote control 9. When the determination is affirmed, the process is ended. When the determination is negated, processing returns to Step S10.

Thus, the control circuit 1 repeatedly stores the swept path point associated with the present clock time when the present position is detected with the predetermined interval (for example, every 50 m or 100 m distance interval) until the operation signal for termination is inputted via the operation device 4 or the remote control 9. Swept path data is thereby created by including multiple swept path points. The creation process (Step S12 in particular) executed by the control circuit 1 serves as a swept path creation means or unit. In other words, the swept path data includes multiple swept path points, which are associated with each other in series. Thus, the external memory 5 stores or records the swept path data including the multiple swept path points.

In addition, multiple swept path data can be stored in the external memory 5. For instance, first swept path data and second swept path data can be separately created and recorded in the external memory 5 depending on a first swept path route and a second swept path route respectively regardless of whether the first and second swept path routes are included in only one area or in mutually different areas.

Moreover, the swept path points, i.e., swept path data, may be stored in an internal memory of the control circuit 1 instead of the external memory 5.

As explained above, the present clock time is used as information indicating the detection order in which present positions of the vehicle are detected. Without the limitation to the above, another information can be substituted as long as the information indicates the detection order of the present positions.

Moreover, in the present embodiment, to create swept path data, the swept path points are recorded to associate with each other (i) corresponding detected present positions and (ii) information items indicative of the detection orders in which the present positions are individually detected. Without the limitation to the above, another may be adopted. For example, present positions of the vehicle may be stored, in a storage device such as the external memory 5, in order that the present positions are detected without being associated with any time information item. Even in such a case, the present positions detected every predetermined distance interval can be stored in the storage device such that the detection orders of the present positions are identifiable. The swept path data indicating a swept path can be thereby also created and the object of the present embodiment can be attained.

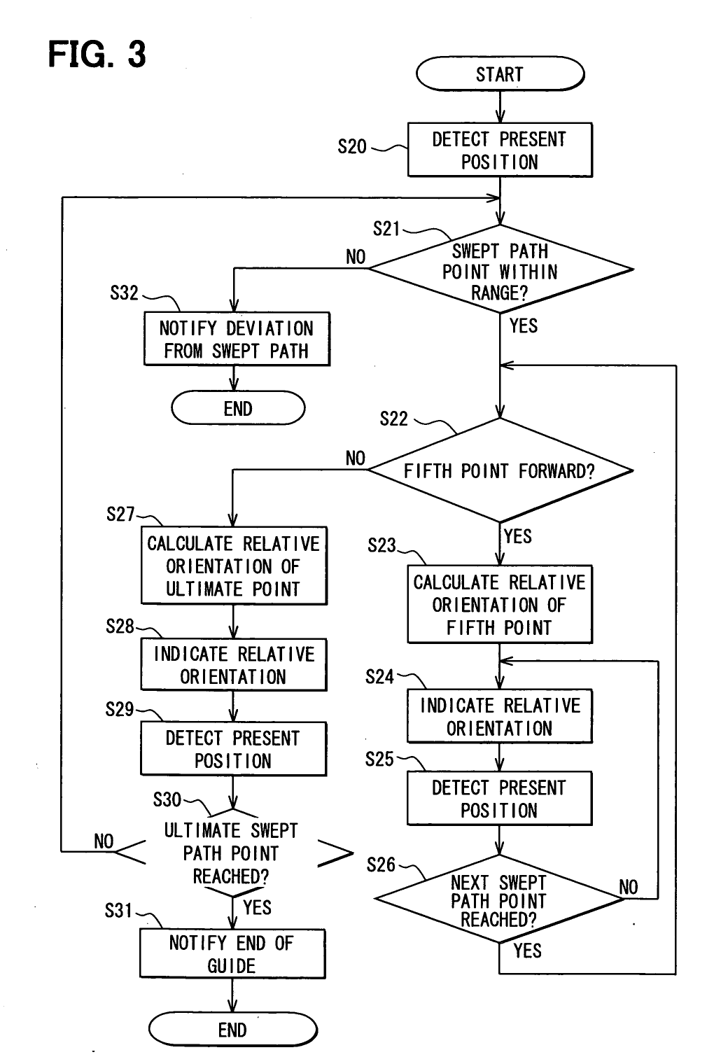

Next, a travel guide process performed by the control circuit 1 will be explained below with reference to FIGS. 3 to 5. The travel guide process is performed based on the recorded swept path data.

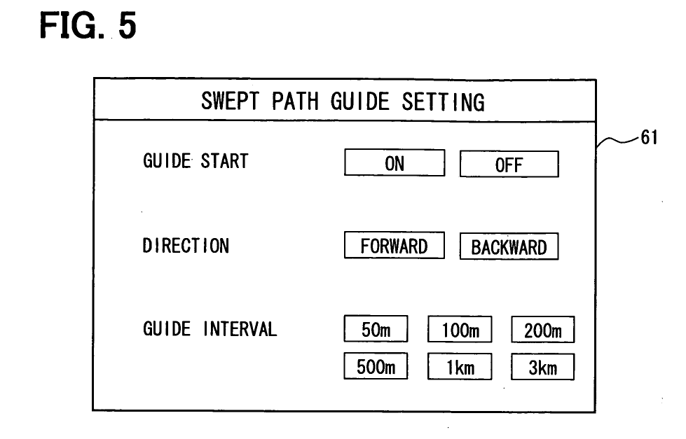

The travel guide process is started after three types of operation signals are inputted via the operation device 4 or the remote control 9 as follows. The first operation signal indicates execution of a travel guide based on the swept path data; the second operation signal indicates a travel direction, forward or backward, in the swept path; and the third operation signal indicates, of swept path points, a guide interval at which the relative orientation is indicated or outputted. Here, the operation device 4 or the remote control 9 can serve as a demand means or unit for the start of the process, the travel direction, or the guide interval. For example, as shown in FIG. 5, a display window may be prepared in the display screen 61 of the display device 6 for the user to input (i) a demand for the start of the swept path guide, (ii) the direction of the swept path guide, and (iii) a guide interval of the swept path guide (e.g., distance interval between points for guide). In the present embodiment, when GUIDE START “ON,” DIRECTION “FORWARD,” and “GUIDE INTERVAL “500 m” are pressed (i.e., three conditions are fulfilled), the travel guide process is started. The meaning of “GUIDE INTERVAL “500 m” is that a swept path point 500 m (or five swept path points) ahead of the present position is designated as a guide target point of which the relative orientation is indicated or outputted at the present position.

Moreover, when multiple swept path data are stored, an additional condition may be included to select one of the multiple swept path data.

At Step S20, the control circuit 1 detects a present position of the vehicle using the position detection unit 2. At Step S21, the control circuit 1 refers to the swept path data stored in the external memory 5 to thereby determine whether or not a swept path point is present within a predetermined range from the present position detected at Step S20. When the determination is affirmed, processing proceeds to Step S22. When the determination is negated, processing proceeds to Step S32.

At Step S32, the control circuit 1 outputs a message that the present position of the vehicle is deviated from the swept path point (or swept path) via the display device 6 and/or the speaker 7, and ends the process. In the above, the present position of the vehicle is away from the swept path points. In such a case, an orientation relative to the heading direction may be computed with respect to a swept path point closest to the present position.

In contrast, when it is determined that a swept path point is present within the predetermined range from the present position, processing proceeds to S22. At Step S22, the control circuit 1 determines whether or not the fifth swept path point is present in the forward direction (i.e., in a predetermined distance interval ahead). When the determination is affirmed, processing proceeds to Step S23. When negated, the vehicle is assumed to approach the ultimate swept path point of the swept path; then, processing proceeds to Step S27. In the present embodiment, it is determined whether the fifth swept path point is present in the forward direction from the present position. Without the limitation to the above, another may be adopted. As long as it is determined whether a swept path point is present with a predetermined distance interval ahead of the vehicle, the object of the present invention can be attained.

At Step S23, an orientation of the fifth swept path point is calculated relative to the heading direction at the present position. In the present embodiment, “500 m” is selected as an interval between guide target points; thus, the relative orientation of the swept path point 500 m (or five swept path points) ahead of the present position is calculated. The control circuit 1 calculates a heading direction of the vehicle at the present position based on a signal from the gyroscope 2b or the like. Thus, the control circuit 1 also serves as a heading direction detection means or unit. The control circuit 1 selects, from the swept path data, a swept path point five swept path points ahead of the swept path point closest to the present position of the vehicle. That is, the control circuit 1 selects the swept path point associated with the clock time proceeding by five clock times from the clock time associated with the swept path point closest to the present position of the vehicle. The control circuit 1 then calculates an orientation of the fifth swept path point relative to the heading direction of the vehicle at the present position. Thus, the swept path data in the present embodiment includes swept path points individually associated with the clock times (i.e., detection order); therefore, the swept path point five swept path points ahead can be selected. In the present embodiment, the processes are explained in the case where the vehicle travels or follows the swept path in the forward direction. In contrast, when the vehicle travels the swept path in the backward direction, the fifth swept path point in the backward direction is selected by tracking back the clock times associated with the swept path points.

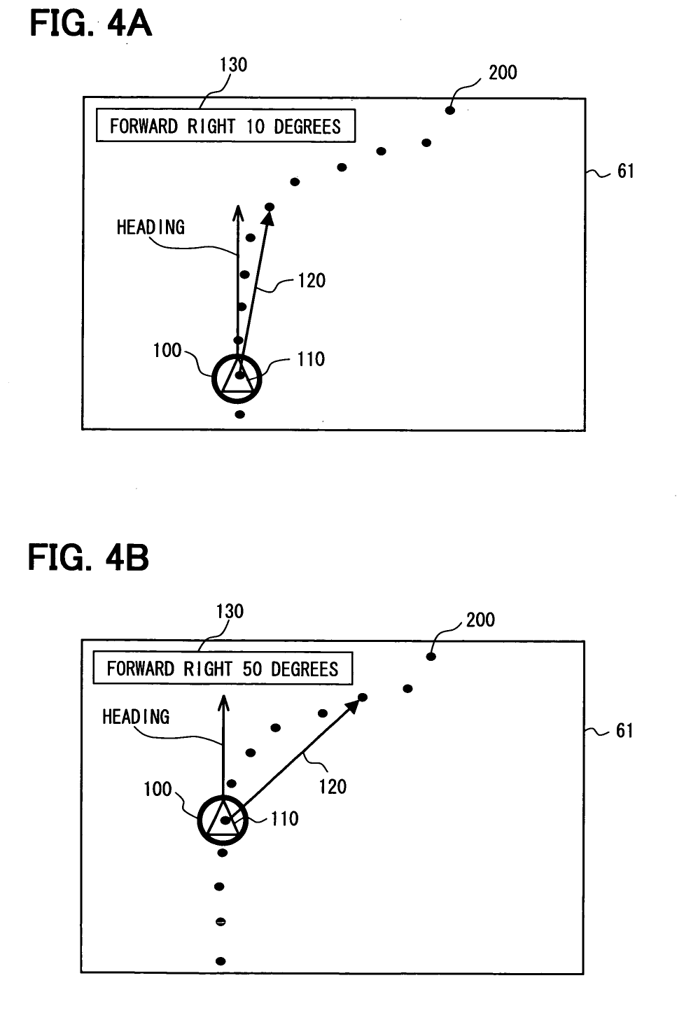

At Step S24, as illustrated in FIGS. 4A, 4B, the control circuit 1 displays, on the display screen 61 of the display device 6, the following: a vehicle mark 100 indicating a present position of the vehicle, a direction mark 110 indicating a heading direction of the vehicle, swept path point marks 200 indicating swept path points, an arrow 120 indicating a relative orientation calculated at Step S23, and characters 130. Further, the control circuit 1 simultaneously outputs an audio guide to indicate the relative orientation via the speaker 7. The travel guide can be thereby executed with respect to the swept path. Thus, the travel guide process (in particular Steps S23, S24, and Steps S27, S28 to be explained later) executed by the control circuit 1 serves as a travel guide means or unit.

In the present embodiment, the relative orientation is indicated using the image (the arrow 120, the character 130) and the sound. Without the limitation to the above, another may be adopted. The object of the present embodiment can be attained by indicating the relative orientation at least using the sound. In the present embodiment, the swept path point marks 200 are illustrated in addition to the relative orientation on the display screen 61 of the display device 6. Without the limitation to the above, another may be adopted. The object of the present embodiment can be attained by indicating at least the relative orientation. It is noted that the travel guide based on the swept path can be intelligibly demonstrated to the user by displaying the swept path point marks 200 in addition to the relative orientation on the display screen 61 of the display device 6.

Moreover, the relative orientation may be sounded when exceeding a predetermined angle (for example, 45 degrees or more). For example, as illustrated in FIG. 4A, when the relative orientation is 10 degrees, the relative orientation is shown only by the image (the arrow 120, the character 130). For example, as illustrated in FIG. 4B, when the relative orientation is 50 degrees, the relative orientation is indicated or outputted by the image (the arrow 120, the character 130) and the sound. When the change in the heading direction of the vehicle is not so great, frequent sound outputs may disturb the user. If the sound output is made only when the relative orientation is not less than the predetermined angle, the user may not be annoyed at the output so much.

At Step S25, the control circuit 1 detects a present position of the vehicle using the position detection unit 2. At Step S26, the control circuit 1 checks the present position and the swept path data to thereby determine whether the vehicle reaches the next swept path point. When the determination is affirmed, processing returns to Step S22. When the determination is negated, processing returns to Step S24.

Further, when it is determined that the fifth swept path point is not present at Step S22, processing proceeds to Step S27. At Step S27, the control circuit 1 designates the ultimate swept path point in the forward direction of the swept path and calculates an orientation of the ultimate swept path point is calculated relative to the heading direction at the present position of the vehicle. The control circuit 1 calculates the heading direction of the vehicle at the present position based on a signal from the gyroscope 2b or the like. Moreover, the control circuit 1 selects from the swept path data the ultimate swept path point, i.e., the swept path point associated with the most recent clock time in the swept path. The control circuit 1 then calculates an orientation of the ultimate swept path point relative to the heading direction of the vehicle. Thus, the swept path data in the present embodiment includes swept path points individually associated with the clock times (e.g., detection order); therefore, the ultimate swept path point in the forward direction can be selected. In the present embodiment, the processes are explained in the case where the vehicle travels the swept path in the forward direction. In contrast, when the vehicle travels the swept path in the backward direction, the ultimate swept path point in the backward direction is selected by tracking back the clock times associated with the swept path points.

At Step S28, like at Step S24, the control circuit 1 displays, on the display screen of the display device 6, a vehicle mark 100 indicating a present position of the vehicle, a direction mark 110 indicating a heading direction of the vehicle, swept path point marks 200 indicating swept path points, an arrow 120 indicating a relative orientation calculated at Step S27, and characters 130. Further, the control circuit 1 simultaneously outputs a sound or audio guide to indicate the relative orientation via the speaker 7. The travel guide can be thereby executed with respect to the swept path.

At Step S29, the control circuit 1 detects a present position of the vehicle using the position detection unit 2. At Step S30, the control circuit 1 checks the present position and the swept path data to thereby determine whether the vehicle reaches the ultimate swept path point. When the determination is affirmed, processing returns to Step S31. When the determination is negated, processing returns to Step S21.

At Step S31, the control circuit 1 outputs a message of termination of the guide on the display screen of the display device 6, and ends the process.

In the present embodiment, the swept path points included in the swept path data have not only information indicative of the positions of the swept path points but also associated information indicative of the inter-relational order of the swept path points. Therefore, when executing the travel guide according to the swept path, the orientation of the following swept path relative to the heading direction can be indicated or guided. Therefore, when executing the travel guide according to the swept path, the travel guide can be executed much more appropriately.

Moreover, in the present embodiment, the relative orientation can be outputted using sounds. This can help prevent the user or driver from gazing at the display screen on the display device 6.

Moreover, the orientation of the most adjacent swept path point relative to the heading direction at the present position is typically similar to the heading direction. Therefore, as explained in the present embodiment, the orientation of the following swept path relative to the heading direction at the present position is calculated and indicated with respect to the fifth swept path point (which is ahead of the present position a predetermined distance interval) in the forward direction. Thus, the heading direction to the distant swept path point can be preferably indicated in advance.

As shown in FIG. 5, a guide interval between guide target points can be designated so that a travel guide can be performed appropriately based on the method, state, etc. of each travel. That is, an appropriate travel guide can be made, for instance, when running a vast area like a desert, running a narrow mountain path etc., or running an off-road course.

Moreover, when there is no swept path point within a predetermined range from the present position of the vehicle, a report may be issued to indicate that the vehicle is deviated from the swept path. Since it may be hard to check whether the vehicle is deviated from the swept path in areas having no roads, the report can help prevent the vehicle from greatly deviating from the swept path. While the report is issued, the orientation of the nearest swept path point relative to the heading direction of the vehicle at the present position may be more preferably indicated by the image and/or the sound.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

Aspects of the disclosure described herein are set out in the following clauses.

As an aspect of the disclosure, a navigation apparatus in a vehicle for providing a travel guide in an area having no roads is provided as follows. The navigation apparatus is provided as follows. A position detection unit is configured to detect a present position of the vehicle. A heading direction detection unit is configured to detect a heading direction of the vehicle. A swept path creation unit is configured to record, in a storage device, present positions detected by the position detection unit with predetermined distance intervals as swept path points such that individual detection orders, in which the present positions are detected, are identifiable, to thereby create swept path data indicative of a swept path of the vehicle. A travel guide unit is configured to provide a travel guide for a route following the swept path forward or backward by outputting a relative orientation of one of the swept path points with respect to the heading direction at the present position using a sound.

Thus, the present positions of the vehicle are detected as swept path points with predetermined distance intervals and stored in the storage device such that detection orders for the swept path points are identifiable. The relative orientation of each swept path point relative to the heading direction of the vehicle can be indicated. Moreover, the relative orientation can be outputted using sounds, i.e., announced. This can help prevent the user or driver from gazing at the display screen on the display device.

As an optional aspect, the travel guide unit may be further configured to output the relative orientation using a display image in addition to the sound.

As an optional aspect, the travel guide unit may be further configured to output the swept path points using a display image.

As an optional aspect, when the relative orientation is greater than or equal to a predetermined angle, the travel guide unit may be configured to output the relative orientation using the sound.

When the change in the heading direction of the vehicle is not so great, frequent sound outputs may disturb the user or driver. If the sound output is made only when the change, i.e., relative orientation is not less than the predetermined angle, the user may not be uncomfortable at the sound output so much.

As an optional aspect, the travel guide unit may be configured to output the relative orientation of a swept path point in the swept path a predetermined distance interval ahead of the present position.

Thus, the relative orientation of the swept path point distant from the present position can be indicated in advance.

As an optional aspect, the predetermined distance interval may be allowed to be set by a user of the vehicle. Thus, a travel guide can be performed appropriately based on the method, state, etc. of the travel. That is, an appropriate travel guide can be made, for instance, when running a vast area like a desert, running a narrow mountain path etc., or running an off-road course.

As an optional aspect, a direction demand unit may be configured to output a direction demand signal which indicates which direction, forward direction or backward direction, the vehicle travels in the swept path. Here, the travel guide unit may be configured to select one of the swept path points, which is used as a target point of which the relative orientation is outputted, based on the outputted direction demand signal.

Thus, regardless of whether the vehicle travels the swept path forward or backward, a swept path point as a target point for guide can be selectable.

As an optional aspect, the swept path creation unit may be configured to further record individual clock times, when the present positions as the swept path points are detected, to thereby allow the detection orders of the swept path points to be identifiable.

As an optional aspect, the travel guide unit may be configured to report that the vehicle deviates from the swept path when no swept path points are present within a predetermined range from the present position.

This helps prevent the vehicle from greatly deviating from the swept path.

It will be obvious to those skilled in the art that various changes may be made in the above-described embodiments of the present invention. However, the scope of the present invention should be determined by the following claims.

What is claimed is:

1. A navigation apparatus in a vehicle for providing a travel guide in an area having no roads, the apparatus comprising:
a position detection unit configured to detect a present position of the vehicle;
a heading direction detection unit configured to detect a heading direction of the vehicle;
a swept path creation unit configured to record, in a storage device, present positions detected by the position detection unit with predetermined distance intervals as swept path points such that individual detection orders, in which the present positions are detected, are identifiable, to thereby create swept path data indicative of a swept path of the vehicle; and
a travel guide unit configured to provide a travel guide for a route following the swept path forward or backward by outputting a relative orientation of one of the swept path points with respect to the heading direction at the present position using a sound.

2. The navigation apparatus according to claim 1, wherein
the travel guide unit is further configured to output the relative orientation using a display image in addition to the sound.

3. The navigation apparatus according to claim 1, wherein
the travel guide unit is further configured to output the swept path points using a display image.

4. The navigation apparatus according to claim 1, wherein
when the relative orientation is greater than or equal to a predetermined angle, the travel guide unit is configured to output the relative orientation using the sound.

5. The navigation apparatus according to claim 1, wherein
the travel guide unit is configured to output the relative orientation of a swept path point in the swept path a predetermined distance interval ahead of the present position.

6. The navigation apparatus according to claim 5, wherein
the predetermined distance interval is allowed to be set by a user of the vehicle.

7. The navigation apparatus according to claim 1, further comprising:
a direction demand unit configured to output a direction demand signal which indicates which direction, forward direction or backward direction, the vehicle travels in the swept path,
wherein the travel guide unit is configured to select one of the swept path points, which is used as a target point of which the relative orientation is outputted, based on the outputted direction demand signal.

8. The navigation apparatus according to claim 1, wherein
the swept path creation unit is configured to further record individual clock times, when the present positions as the swept path points are detected, to thereby allow the detection orders of the swept path points to be identifiable.

9. The navigation apparatus according to claim 8, wherein
the travel guide unit is configured to report that the vehicle deviates from the swept path when no swept path points are present within a predetermined range from the present position.
